(19) United States
(12) Patent Application Publication
(10) Pub. No.: US 2010/0028545 A1
(43) Pub. Date: Feb. 4, 2010

(54) POLYMER SOLUTION, MANUFACTURING METHOD THEREOF, AND MANUFACTURING METHOD OF TRANSPARENT CONDUCTIVE POLYMER FILM

(75) Inventor: Young-min Choi, Seoul (KR)

Correspondence Address: MILLER, MATTHIAS & HULL, ONE NORTH FRANKLIN STREET, SUITE 2350, CHICAGO, IL, 60606, US

(73) Assignees: KYUNG SIK KIM, Seoul (KR); YOUNG JIN KIM, Seoul (KR); KYO JIN LEE, Seoul (KR); MASAMI GOTO, Tokyo (JP)

(21) Appl. No.: 12/185,679

(22) Filed: Aug. 4, 2008

(51) Int. Cl. B05D 3/02; C08L 29/04

(52) U.S. Cl. 427/385.5; 525/57

(57) ABSTRACT

Provided are a polymer solution to be coated to manufacture a transparent conductive polymer film, a method of manufacturing the polymer solution, and a method of manufacturing a transparent conductive polymer film using the polymer solution. The polymer solution includes: polyvinyl alcohol (PVA) for controlling electrical conductivity of the transparent conductive polymer film; polyvinylacetamide (PNVA) for controlling structural strength of the polymer solution; polyacrylamide (PAAM) for controlling frictional resistance and an adhesion characteristic; nitric acid functioning as an electron-acceptor in an oxidation-reduction reaction; methyl methacrylate (MMA) for controlling transmittance of the transparent conductive polymer film; and a normal methyl pyrrolidone (AMP) solvent for maintaining viscosity of the polymer solution. A polymer solution can be manufactured without using metals, carbon powder, or oxides, and a transparent conductive polymer film with high electrical conductivity and good transmittance can be manufactured using the polymer solution.

### BACKGROUND

1. Technical Field

A polymer solution, a method of manufacturing the same, and a method of manufacturing a transparent conductive polymer film are disclosed. More particularly, a polymer solution is disclosed that is used for manufacturing a transparent conductive polymer film with good optical transmittance and high conductivity. Further, a method of manufacturing the polymer solution and a method of manufacturing a transparent conductive polymer film using the polymer solution are also disclosed.

2. Description of the Related Art

A conventional conductive polymer solution is manufactured using metals, carbon powder, and oxides, which affect electrical conductivity and transmittance. In spite of a great deal of trial and error, it is still difficult to manufacture a transparent conductive polymer film with high electrical conductivity and good transmittance.

### SUMMARY OF THE DISCLOSURE

A disclosed polymer solution may be used to manufacture a highly conductive transparent polymer film without using metals, carbon powder, or oxides.

Also, a disclosed method of manufacturing a polymer solution may be used to manufacture a highly conductive transparent polymer film without using metals, carbon powder or oxides.

A disclosed method of manufacturing produces a highly conductive transparent polymer film without using metals, carbon powder, or oxides.

In a refinement, a polymer solution is disclosed for the manufacture of a transparent conductive polymer film. The polymer solution includes: from about 11 to about 13.5% by weight polyvinyl alcohol (PVA) for controlling electrical conductivity of the transparent conductive polymer film; from about 11 to about 13.5% by weight polyvinylacetamnide (PNVA) for controlling structural strength of the polymer solution; from about 11 to about 13.5% by weight polyacrylarnide (PAAM) for controlling fictional resistance and an adhesion characteristic; from about 11 to about 13.5% by weight nitric acid functioning as an electron-acceptor in an oxidation-reduction reaction; from about 5 to about 20% by weight methyl methacrylate (MMA) for controlling transmittance of the transparent conductive polymer film; and from about 30 to about 50% by weight a normal methyl pyrrolidone (NMP) solvent for maintaining viscosity of the polymer solution.

The transparent conductive polymer film may have an optical transmittance of from about 75 to about 98% and a resistivity of from about 0.1×10⁻² to about 1×10³ Ω·cm.

In another refinement, a method of manufacturing a polymer solution is disclosed wherein the solution is used for forming a transparent conductive polymer film. The method includes: obtaining PVA for controlling electrical conductivity of the transparent conductive polymer film; combining PVA with PNVA for controlling structural strength of the polymer solution in a stirrer; injecting PAAM for controlling frictional resistance and an adhesion characteristic, and nitric acid functioning as an electron-acceptor in an oxidation-reduction reaction, into the stirrer and mixing the PAAM and the nitric acid; injecting an NMP solvent for maintaining viscosity of the polymer solution into the stirrer and stirring; and injecting MMA for controlling transmittance of the transparent conductive polymer film into the stirrer and stirring. In this case, from about 11 to about 13.5% by weight PVA, from about 11 to about 13.5% by weight PNVA, from about 11 to about 13.5% by weight PAAM, from about 11 to about 13.5% by weight nitric acid, from about 5 to about 20% by weight MMA, and from about 30 to about 50% by weight the NMP solvent are injected into the stirrer.

The obtaining ot the PVA may include: injecting vinyl acetate and methyl alcohol into the stirrer and injecting a first sodium hydroxide (NaOH) solution into the stirrer and stirring; filtering and drying a precipitate formed in the stirrer; injecting the filtered and dried precipitate and distilled water into a reactor and heating the reactor; cooling the reactor, injecting a second NaOH solution into the reactor and stirring; and injecting sulfuric acid (H₂SO₄) into the reactor to cause a reaction.

In another refinement, a method of manufacturing a transparent conductive polymer film is disclosed. The method includes: obtaining PVA for controlling electrical conductivity of the transparent conductive polymer film; combining PVA with PNVA for controlling structural strength of a polymer solution in a stirrer; injecting PAAM for controlling frictional resistance and an adhesion characteristic, and nitric acid functioning as an electron-acceptor in an oxidation-reduction reaction, into the stirrer and mixing the PAAM and the nitric acid; injecting an NMP solvent for maintaining viscosity of the polymer solution into the stirrer and stirring; injecting MMA for controlling transmittance of the transparent conductive polymer film into the stirrer and stirring to obtain the polymer solution; spraying the polymer solution onto a target object via a nozzle to coat the target object with the polymer solution; and drying the coated polymer solution at a temperature of about 80 to 110° C. In this case, from about 11 to about 13.5% by weight PVA , from about 1 I to about 13.5% by weight PNVA, from about 11 to about 13.5% by weight PAAM, from about 11 to about 13.5% by weight nitric acid, from about 5 to about 20% by weight MMA, and from about 30 to about 50% by weight the NMP solvent are injected into the stirrer.

The obtaining of the PVA may include: injecting vinyl acetate and methyl alcohol into the stirrer, injecting a first NaOH solution into the stirrer and stirring; filtering and drying a precipitate formed in the stirrer; injecting the filtered and dried precipitate and distilled water into a reactor and heating the reactor; cooling the reactor, injecting a second NaOH solution into the reactor and stirring; and injecting H₂SO₄ into the reactor to cause a reaction.

A polymer solution can be obtained without using metals, carbon powder, or oxides, unlike conventional conductive polymer solutions. Also, by coating the polymer solution according to the present invention onto a target object, a polymer film with high conductivity and good transmittance can be manufactured.

Other advantages and features will be apparent from the following detailed description when read in conjunction with the attached drawings.

### BRIEF DESCRIPTION OF THE DRAWINGS

For a more complete understanding of the disclosed methods, reference should be made to the example illustrated in greater detail in the accompanying drawing, wherein:

FIG. 1 is a diagram for explaining a process of obtaining polyvinyl acetate via emulsion polymerization of vinyl acetate and manufacturing polyvinyl alcohol (PVA) by hydrolyzing polyvinyl acetate (PVAC).

In certain instances, details which are not necessary for an understanding of the disclosed methods or which render other details difficult to perceive may have been omitted. It should be understood, of course, that this disclosure is not limited to the particular embodiments illustrated herein.

### DETAILED DESCRIPTION OF THE PRESENTLY PREFERRED EMBODIMENTS

Hereinafter, exemplary embodiments of the present invention will be described in detail. However, the present invention is not limited to the exemplary embodiments disclosed below, but can be implemented in various types. Therefore, the present exemplary embodiments are provided for complete disclosure of the present invention and to fully inform the scope of the present invention to those ordinarily skilled in the art.

A polymer solution according to an exemplary embodiment of the present invention may include from about 11 to about 13.5% by weight polyvinyl alcohol (PVA), from about 11 to about 13.5% by weight polyvinylacetamide (PNVA), from about 11 to about 13.5% by weight polyacrylamide (PAAM), from about 11 to about 13.5% by weight nitric acid, from about 30 to about 50% by weight a normal methyl pyrrolidone (NMP) solvent, and from about 5 to about 20% by weight methyl methacylate (CH₂═C(CH₃)CO₂CH₃; MMA)

Polyvinyl alcohol (PVA), which is obtained by hydrolyzing polyvinyl acetate (PVAC) manufactured via emulsion polymerization vinyl acetate, is water-soluble, unlike other synthetic polymers.

PVA has a specific gravity of from about 0.3 to about 0.7 and is thermally stable and thermoplastic at a temperature ranging from about 100 to about 140° C. Although PVA is not externally changed by short-time heating, it starts to undergo structural changes at a temperature of about 150° C., gradually becomes colored at temperatures higher than 150° C., and decomposes at a temperature of about 300° C. Also, PVA melts down in hot water (about 750° C. or higher) but is insoluble and merely swells in cold water. PVA swells or dissolves in acidic or alkaline solutions. PVA is contained in the polymer solution in order to increase tension resistance, tensile strength, elongation, and abrasion resistance. When the polymer solution contains less than about 11% by weight PVA, it becomes less stable, while when it contains more than about 13.5% by weight PVA, it becomes too electrically conductive. Therefore, the polymer solution may contain from about 11 to about 13.5% by weight PVA, more preferably, 12.5% by weight PVA.

PNVA is a nonionic absorbent resin that is applicable to highly ionized water or liquid to which other absorbent resins developed so far cannot be applied. Since PNVA is highly adsorptive to a material containing a phenol hydroxyl radical or protein, PNVA may maintain the structural strength of the polymer solution constant. When the polymer solution contains less than 11% by weight PNVA, its structural strength is reduced, while when it contains more than 13.5% by weight PNVA, PNVA may easily react with compounds in the polymer solution due to its high adsorption capability and be chemically altered. Therefore, the polymer solution may contain from about 11 to about 13.5% by weight PNVA, more specifically, 12.5% by weight PNVA.

PAAM is a linear polymer obtained using acryl amide and used as a flocculant in the polymer solution. Since the viscosity of PAAM hardly varies with pH, PAAM may increase the frictional resistance of a polymer film during fabrication of the polymer film. When the polymer solution contains less than about 11% by weight PAAM, it has a low frictional resistance, while when it contains less than about 13.5% by weight PAAM, it has a poor adhesion characteristic during the fabrication of the polymer film. Therefore, the polymer solution may contain from about 11 to about 13.5% by weight PAAM, more preferably, about 12.5% by weight PAAM.

The nitric acid is completely ionized into ionic hydrogen and nitrate in the polymer solution and functions as an electron-acceptor in an oxidation-reduction reaction. When the polymer solution contains less than about 11% by weight nitric acid, the nitric acid cannot properly function as the electron-acceptor in the oxidation-reduction reaction in the polymer solution, while when the polymer solution contains more than about 13.5% by weight nitric acid, the nitric acid functions as a strong oxidizer in the polymer solution, thereby adversely affecting electrical conductivity. Therefore, the polymer solution may contain from about 11 to about 13.5% by weight nitric acid, more preferably, about 12.5% by weight nitric acid.

The NMP solvent is a functional chemical used as an environmentally friendly semiconductor cleaner because it is good at dissolving organic material and has low toxicity. The NMP solvent serves to maintain the viscosity of compounds in the polymer solution. When the polymer solution contains less than about 30% by weight the NMP solvent, it is too viscous and thus difficult to spray. Conversely, when the polymer solution contains more than about 50% by weight the NMP solvent, its viscosity is low, hinderiing fabrication of a polymer film. Therefore, the polymer solution may contain from about 30 to about 50% by weight the NMP solvent, more preferably, about 40% by weight the NMP solvent.

MMA is a synthetic acrylic resin obtained via polymerization of ester, such as acrylic acid or methacryl acid. MMA is a highly transparent plastic that transmits light (especially ultraviolet (UV) light) more easily than glass. Since MMA is more transparent than glass and has only half the weight of glass, MMA is lightweight and easy to process MMA is directly bonded to polymeric compounds of the polymer solution and affects transmittance and electrical conductivity of a polymer film during fabrication of the polymer film. When the polymer solution contains less than 5% by weight MMA, a binding force between MMA and the polymeric compounds of the polymer solution weakens, while when the polymer solution contains more than 20% by weight MMA, the electrical conductivity of the polymer film may be degraded. Therefore, the polymer solution may contain from about 5 to about 20% by weight MMA, more preferably, about 10% by weight MMA.

A transparent conductive polymer film manufactured using the above-described polymer solution has a resistivity ranging from about 0.1×10⁻² to about 1×10³ Ω·cm, more preferably, 1×10⁻² Ω·cm. Thus, the transparent conductive polymer film has high conductivity and good transmittance. Also, the transparent conductive polymer film has an optical transmittance ranging from about 75 to about 98%.

A method of manufacturing a transparent conductive polymer film using the above-described polymer solution will now be described.

Initially, PVAC is manufactured via emulsion polymerization of vinyl acetate and then hydrolyzed to obtain PVA. Since vinyl alcohol, which is a monomer of PVA, is unstable, PVA is manufactured via polymerization of PVAC instead of vinyl alcohol. Typically, PVA may be manufactured via a transesterification reaction of PVAC using alkali or acid of a methanol solution as a catalyst.

In general, emulsion polymerization may, for example, include adding a solvent, a surfactant, and a reaction initiator to a vinyl acetate monomer, stirring the mixture to form micelles or aggregates, and polymerizing the micelles or aggregates by heating. The emulsion polymerization may be induced under appropriate conditions of reaction time stirring rate, and hydrogen ion concentration. The surfaces of the monomer and polymer are saturated with the surfactant during the polymerization so that the monomer and polymer may be dispersed and dissolved in a dispersion solvent. The surfactant may be a nonionic surfactant, such as polyoxyethylene, or an anionic surfactant, such as alkyl sulfate. The reaction initiator may be potassium persulfate or ammonium persulfate. The solvent may be methyl alcohol. Accordingly, PVAC may be obtained via emulsion polymerization of vinyl acetate, and then hydrolyzed to obtain PVA.

Hereinafter, a method of manufacturing PVA according to an exemplary embodiment of the present invention will be described in more detail.

Table 1 shows the characteristics of materials used for the manufacture of PVA, which involves obtaining PVAC via emulsion polymerization of vinyl acetate and hydrolyzing the PVAC.

TABLE 1

| | | | Melting | Boiling | |
|---|---|---|---|---|---|
| | | Purity | point | point | Specific |
| Chemical name | Formula | (g/mol) | (° C.) | (° C.) | gravity |
| Methyl alcohol | CH₃OH | 32 04 | −97.98 | 64 65 | 0 7928 |
| Sodium hydroxide | NaOH | 40 | 318 | 1390 | 2 13 |
| Sulfuric acid | H₂SO₄ | 98 0734 | 3 | 280 | 1 84 |
| | (purity of | | | | |
| | 95%) | | | | |

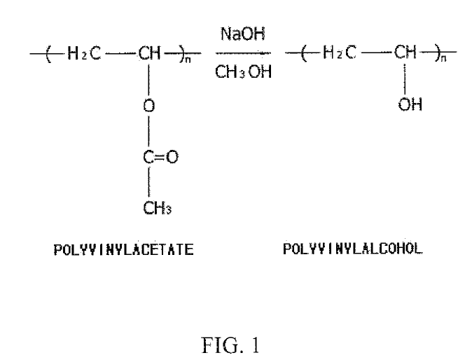

FIG. 1 is a diagram for explaining a process of obtaining polyvinyl acetate via emulsion polymerization of vinyl acetate and manufacturing PVA by hydrolyzing PVAC.

Referring to Table 1 and FIG. 1, 2.0 g of vinyl acetate and 100 Ml of methyl alcohol (CH₃OH) were injected into a stirrer, 2 Ml of 40% sodium hydroxide (NaOH) was then injected into the stirrer, and the stirrer was stirred at a rate of about 600 to 1500 rpm.

After the stirrer was stirred for 20 minutes to 1 hour, it was left to sit for 20 to 30 minutes. As a result, a white precipitate was generated in the stirrer. The white precipitate was filtered via a filter and dried using, for example, a hot-air drying method, thereby producing PVAC.

0.5 g of PVAC and 100 ml of distilled water were injected into a reactor, and the reactor was heated to and maintained at a temperature of about 75° C. for 30 minutes to 1 hour. Thereafter, the reactor was cooled down to room temperature. 2 ml of 40% NaOH was injected into the reactor and the reactor was stirred for 20 minutes to 1 hour. After the stirring process, the reactor was allowed to sit for one and a half to two hours, and then sulfuric acid (H₂SO₄) was injected into the reactor to cause a reaction and produce PVA.

11 to 13.5% by weight the resultant PVA was combined with from about 11 to about 13.5% by weight PNVA. PVA was first combined with PNVA before anything else in order to increase the stability of the polymer solution.

After the combination of PVA with PNVA, from about 11 to about 13.5% by weight PAAM and from about 11 to about 13.5% by weight nitric acid were added to the combination. Here, care must be taken not to gel the polymer solution. Also, the nitric acid functions as an electron-acceptor in an oxidation-reduction reaction in the polymer solution and makes electrical conductivity and a binding force between polymeric compounds of the polymer solution constant.

30 to 50% by weight the NMP solvent was added to the mixture containing PMMA and the nitric acid and the resultant mixture was stirred. During the stirring process, the NMP solvent may react with the polymeric compounds of the polymer solution so as to maintain the polymer solution appropriately viscous. Here, a stirrer was stirred at a rate of about 600 to 1500 rpm.

After the NMP solvent was added, from about 5 to about 20% by weight MMA was added to the mixture and the resultant mixture was stirred again. Again, the stirrer was stirred at a rate of about 600 to 1500 rpm. MMA is directly bonded to the polymeric compounds of the polymer solution and affects transmittance and electrical conductivity of a polymer film during fabrication of the polymer film. In addition, MMA allows the polymer solution to have a resin composition.

The above-described process of manufacturing the polymer solution according to an exemplary embodiment of the present invention may be performed at a normal temperature of about 10 to 30° C.

The polymer solution according to an exemplary embodiment of the present invention obtained by the above-described process is water-based.

Hereinafter, a method of manufacturing a transparent conductive polymer film will be described.

The polymer solution is sprayed via a nozzle onto a target object, such as an acrylic film. Thereafter, the polymer solution is dried using a hot-air drying method at a temperature of about 80 to 110° C., thereby manufacturing the transparent conductive polymer film. In this case, when the polymer solution is dried at a temperature lower than 80° C., it cannot be shaped into a proper film. Also, when the polymer solution is dried at a temperature of higher than 110° C., it may be damaged due to excessive heating. Therefore, the sprayed polymer solution may be dried at a temperature of about 80 to 110° C.

While only certain embodiments have been set forth, alternatives and modifications will be apparent from the above description to those skilled in the art. These and other alternatives are considered equivalents and within the spirit and scope of this disclosure and the appended claims.

1. A polymer solution coating for use in manufacturing a transparent conductive polymer film, the polymer solution coating comprising:
polyvinyl alcohol (PVA);
polyvinylacetamide (PNVA);
polyacrylamide (PAAM);
nitric acid;
methyl methacrylate (MMA); and
normal methyl pyrrolidone (NMP) solvent.

2. The polymer solution coating according to claim 1 wherein the polymer solution coating is further characterized as comprising:
from about 11 to about 13.5% by weight polyvinyl alcohol (PVA);
from about 11 to about 13.5% by weight polyvinylacetamide (PNVA);
from about 11 to about 13.5% by weight polyacrylamide (PAAM);
from about 11 to about 13.5% by weight nitric acid;
from about 5 to about 20% by weight methyl methacrylate (MMA); and
from about 30 to about 50% by weight a normal methyl pyrrolidone (NMP) solvent.

3. The polymer solution coating according to claim 1, wherein the transparent conductive polymer film has an optical transmittance ranging from about 75 to about 98% and a resistivity ranging from about 0.1×10⁻² to about 1×10³ Ω·cm.

4. The polymer solution coating according to claim 2, wherein the polyvinyl alcohol (PVA) controls electrical conductivity of the transparent conductive polymer film.

5. The polymer solution coating according to claim 2, wherein the polyvinylacetamide (PNVA) controls structural strength of the transparent conductive polymer film.

6. The polymer solution coating according to claim 2, wherein the polyacrylamide (PAAM) controls frictional resistance and adhesion qualities of the transparent conductive polymer film.

7. The polymer solution coating according to claim 2, wherein the nitric acid functions as an election-acceptor in an oxidation-reduction reaction.

8. The polymer solution coating according to claim 2, wherein the methyl methacrylate (MMA) controls transmittance of the transparent conductive polymer film.

9. The polymer solution coating according to claim 2, wherein the normal methyl pyrrolidone (NMP) solvent for maintains a viscosity of the polymer solution coating.

10. A method of manufacturing a polymer solution coating for forming a transparent conductive polymer film, the method comprising:
providing a polyvinyl alcohol (PVA) solution;
combining the PVA solution with a polyvinylacetamide (PNVA) solution in a stirrer;
adding a polyacrylamide (PAAM) solution and a nitric acid solution to the stirrer and mixing the PAAM and the nitric acid with the PVA and PNVA;
adding a normal methyl pyrrolidone (NMP) solvent to the stirrer; and
adding methyl methacrylate (MMA) into the stirrer and mixing to provide a polymer solution coating.

11. The method according to claim 10 wherein, after the MMA is added, the polymer solution coating comprises from about 11 to about 13.5% by weight PVA.

12. The method according to claim 10 wherein after the MMA is added, the polymer solution coating comprises from about 11 to about 13.5% by weight PNVA.

13. The method according to claim 10 wherein after the MMA is added, the polymer solution coating comprises from about 1 to about 13.5% by weight PAAM.

14. The method according to claim 10 wherein after the MMA is added, the polymer solution coating comprises from about 11 to about 13.5% by weight nitric acid.

15. The method according to claim 10 wherein after the MMA is added, the polymer solution coating comprises from about 5 to about 20% by weight MMA.

16. The method according to claim 10 wherein after the MMA is added, the polymer solution coating comprises from about 30 to about 50% by weight the NMP.

17. The method according to claim 10, wherein the obtaining of the PVA comprises:
injecting vinyl acetate and methyl alcohol into the stirrer, and injecting a first sodium hydroxide (NaOH) solution into the stirrer and stirring;
filtering and drying a precipitate formed in the stirrer;
injecting the filtered and dried precipitate and distilled water into a reactor and heating the reactor;
cooling the reactor, injecting a second NaOH solution into the reactor and stirring; and
injecting sulfuric acid (H₂SO₄) into the reactor to cause a reaction.

18. A method of manufacturing a transparent conductive polymer film, comprising:
obtaining polyvinyl alcohol (PVA) for controlling electrical conductivity of the transparent conductive polymer film;
combining PVA with polyvinylacetamide (PNVA) fox controlling structural strength of a polymer solution in a stirrer;
injecting polyacrylamide (PAAM) for controlling frictional resistance and an adhesion characteristic, and nitric acid functioning as an electron-acceptor in an oxidation-reduction reaction, into the stirrer and mixing the PAAM and the nitric acid;
adding a normal methyl pyrrolidone (NMP) solvent to the stirrer for maintaining viscosity of the polymer solution into the stirrer and stirring;
adding methyl methacrylate (MMA) to the stirrer for controlling transmittance of the transparent conductive polymer film into the stirrer and stifling to obtain the polymer solution;
spraying the polymer solution onto a target object via a nozzle to coat the target object with the polymer solution; and
drying the coated polymer solution at a temperature of about 80 to 110° C.,
wherein, after the MMA is added to the stirrer, the polymer solution comprises from about 11 to about 13.5% by weight PVA, from about 11 to about 13.5% by weight PNVA, frp, about 11 to about 13.5% by weight PAAM, from about 11 to about 13.5% by weight nitric acid, from about 5 to about 20% by weight MMA, and from about 30 to about 50% by weight the NMP solvent.

19. The method according to claim 18, wherein the obtaining of the PVA comprises:
injecting vinyl acetate and methyl alcohol into the stirrer, and injecting a first sodium hydroxide (NaOH) solution into the stirrer and stirring;
filtering and drying a precipitate formed in the stirrer;
injecting the filtered and dried precipitate and distilled water into a reactor and heating the reactor;
cooling the reactor, injecting a second NaOH solution into the reactor and stirring; and
injecting sulfuric acid (H₂SO₄) into the reactor to cause a reaction.
